(19) United States
(12) Patent Application Publication
(10) Pub. No.: US 2005/0145451 A1
(43) Pub. Date: Jul. 7, 2005

(54) Adapter for vehicle brake assembly

(76) Inventors: Dennis Kelly, Ypsilanti, MI (US); Don Siekas, Farmington Hills, MI (US); Anthony Schmandt, Walled Lake, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/737,311

(22) Filed: Dec. 16, 2003

(51) Int. Cl. F16D 51/00

(52) U.S. Cl. 188/79.54

(57) ABSTRACT

This invention relates to an adapter for a vehicle brake assembly. The vehicle brake assembly is a vehicle drum-in-hat disc brake assembly having a disc service brake and a drum-in-hat parking and emergency brake. The vehicle drum-in-hat disc brake assembly includes a backing plate having a centrally located first aperture formed therein; a drum brake shoe assembly of the drum-in-hat parking and emergency brake supported by the backing plate; and a drum-in-hat adapter having a centrally located second aperture and a plurality of smaller mounting apertures formed therein about the centrally located first aperture thereof, wherein the adapter is formed as a one piece stamping and including an integral abutment member formed therewith during the stamping thereof.

### BACKGROUND OF THE INVENTION

This invention relates in general to vehicle drum brake assemblies and drum-in-hat disc brake assemblies and in particular to an adapter for use in such a vehicle drum brake assembly and drum-in-hat disc brake assembly.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. In some instances, the disc brake assembly can be a “drum-in-hat” type of disc brake assembly. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical drum-in-hat type of disc brake assembly includes a hydraulically or pneumatically actuated disc service brake and a mechanically actuated drum-in-hat parking and emergency brake. The disc service brake includes a rotor which is secured to the wheel of the vehicle for rotation therewith. The rotor includes a pair of opposed friction plates which are selectively engaged by portions of a caliper assembly. The interior of the rotor defines a cylindrical braking surface.

A caliper assembly is slidably supported by pins secured to a mounting flange. The mounting flange is secured to a non-rotatable component of the vehicle, such as the steering knuckle or the axle flange. The caliper assembly includes a pair of brake shoes which are disposed on opposite sides of the rotor. The brake shoes are operatively connected to one or more hydraulically actuated pistons for movement between a non-braking position, wherein they are spaced apart from the opposed friction plates of the rotor, and a braking position, wherein they are moved into frictional engagement with the opposed friction plates of the rotor. When the operator of the vehicle depresses the brake pedal, the piston urges the brake shoes from the non-braking position to the braking position so as to frictionally engage the friction plates of the rotor and thereby slow or stop the rotation of the associated wheel of the vehicle.

The drum-in-hat parking and emergency brake includes a pair of opposed arcuate brake shoes which are supported on a backing plate for selective movement relative thereto. The backing plate is secured to the mounting flange, or alternatively, can be formed integral therewith. Each of the brake shoes has a friction pad or lining secured thereto. The brake shoes extend within the cylindrical braking surface of the rotor. To effect parking and emergency braking action, the operator of the vehicle manually pulls an actuating lever. The lever is connected to an actuation cable having a park brake cable end which, when pulled, actuates a mechanical actuating mechanism. The actuating mechanism is located adjacent one of the ends of the brake shoes and is operative to move the brake shoes outwardly apart from one another such that the friction pads frictionally engage the cylindrical braking surface of the rotor. Such frictional engagement causes slowing or stopping of the rotational movement of the rotor and, therefore, the wheel of the vehicle in a controlled manner.

A typical drum brake assembly includes a backing plate which is secured to a fixed, non-rotatable component of the vehicle, such as the vehicle axle housing. A pair of opposed arcuate brake shoes are supported on the backing plate for selective movement relative thereto. Each of the brake shoes has a friction pad secured thereto. The brake drum assembly further includes a cylindrical brake drum which is secured to the vehicle wheel for rotation therewith. The interior of the brake drum is hollow, defining an inner cylindrical braking surface. The brake drum is disposed adjacent to the backing plate such that the brake shoes extend within the inner cylindrical braking surface. To effect braking action, the brake shoes are moved outwardly apart from one another such that the friction pads frictionally engage the inner cylindrical braking surface of the brake drum. Such frictional engagement causes slowing or stopping of the rotational movement of the brake drum and, therefore, the wheel of the vehicle in a controlled manner.

One or more actuating mechanisms are provided in the brake drum assembly for selectively moving the brake shoes outwardly apart from one another into frictional engagement with the cylindrical braking surface of the brake drum. Usually, a hydraulically or pneumatically actuated service brake mechanism is provided for selectively actuating the drum brake assembly under normal operating conditions. Such a service brake mechanism can include a hydraulic cylinder having a pair of opposed pistons which abut and move the brake shoes apart from one another into frictional engagement with the cylindrical braking surface of the brake drum.

A mechanically actuated parking and emergency brake mechanism is also usually provided for selectively actuating the drum brake assembly. The parking and service brake mechanism can include an actuating lever pivotally supported on one of the brake shoes. The actuating lever is connected to a cable which, when pulled, moves the brake shoes apart from one another into frictional engagement with the cylindrical braking surface of the brake drum.

### SUMMARY OF THE INVENTION

This invention relates to an adapter for a vehicle brake assembly. The vehicle brake assembly is a vehicle drum-in-hat disc brake assembly having a disc service brake and a drum-in-hat parking and emergency brake. The vehicle drum-in-hat disc brake assembly includes a backing plate having a centrally located first aperture formed therein; a drum brake shoe assembly of the drum-in-hat parking and emergency brake supported by the backing plate; and a drum-in-hat adapter having a centrally located second aperture and a plurality of smaller mounting apertures formed therein about the centrally located first aperture thereof, wherein the adapter is formed as a one piece stamping and including an integral abutment member formed therewith during the stamping thereof.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a portion of a first embodiment of a vehicle drum-in-hat disc brake assembly constructed in accordance with the present invention.

FIG. 2 is a plan view of the vehicle drum-in-hat disc brake assembly illustrated in FIG. 1.

FIG. 3 is a sectional view of the vehicle drum-in-hat disc brake assembly taken along line 3-3 of FIG. 2.

FIG. 4 is a perspective view of a drum-in-hat adapter of the vehicle drum-in-hat disc brake assembly illustrated in FIGS. 1-3.

FIG. 5 is a plan view of the drum-in-hat adapter of the vehicle drum-in-hat disc brake assembly.

FIG. 6 is a side view of the drum-in-hat adapter of the vehicle drum-in-hat disc brake assembly.

FIG. 7 is a perspective view of a backing plate of the vehicle drum-in-hat disc brake assembly illustrated in FIGS. 1-3.

FIG. 8 is a schematic diagram of a portion of a vehicle including the first embodiment of a vehicle drum-in-hat disc brake assembly illustrated in FIGS. 1-3.

FIG. 9 is a schematic diagram of a portion of a vehicle including a second embodiment of a vehicle drum-in-hat disc brake assembly constructed in accordance with the present invention.

### DETAILED DESCRIPTION OF THE PREFERRED EMBODIMENTS

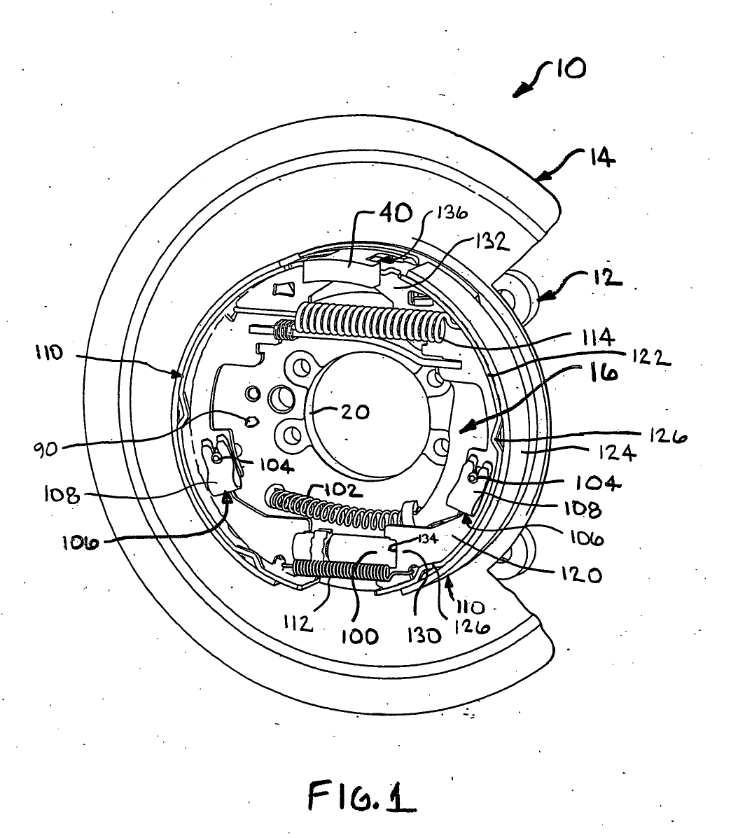

Referring now to the drawings, there is illustrated in FIGS. 1-3 a portion of a drum-in-hat disc assembly, indicated generally at 10, including a brake shoe mounting system in accordance with the present invention. The drum-in-hat disc brake assembly 10 includes a hydraulically or pneumatically actuated disc service brake (not shown), and a drum-in-hat parking and emergency brake. In the illustrated embodiment, the drum-in-hat parking and emergency brake is a sliding shoe type of brake. The general structure and operation of the drum-in-hat disc brake assembly is conventional in the art. Thus, only those portions of the drum-in-hat disc brake assembly which are necessary for a full understanding of this invention will be explained and illustrated in detail. Although this invention will be described and illustrated in connection with the particular vehicle drum-in-hat disc brake assembly 10 disclosed herein, it will be appreciated that this invention may be used in connection with other sliding or pivoting shoe type drum-in-hat disc brake assemblies in connection with the associated parking and emergency brake portion, and with other sliding or pivoting shoe type drum brake assemblies in connection with the associated service brake portion if so desired.

As shown in FIG. 1, the drum-in-hat disc brake assembly 10 includes a drum-in-hat adapter 12, a backing plate or splash shield 14, and a drum-in-hat parking and emergency brake actuation mechanism, a portion of which is indicated generally at 16. According to the present invention, the drum-in-hat adapter 12 is illustrated as being a single, one-piece integral stamped adapter (ISA). The adapter 12 is formed form a suitable material capable of being stamp formed. Examples of such suitable materials can include carbon steel and high strength low alloy (HLSA). When the adapter 12 is formed from one of these or other suitable materials, the adapter 12 preferably can have a generally uniform thickness of approximately 12.5 mm (approximately 0.5 inches).

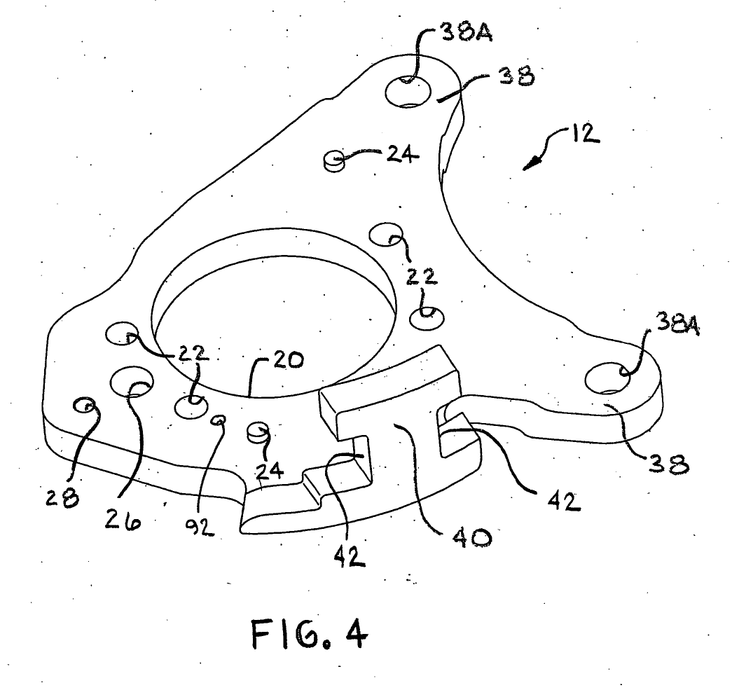

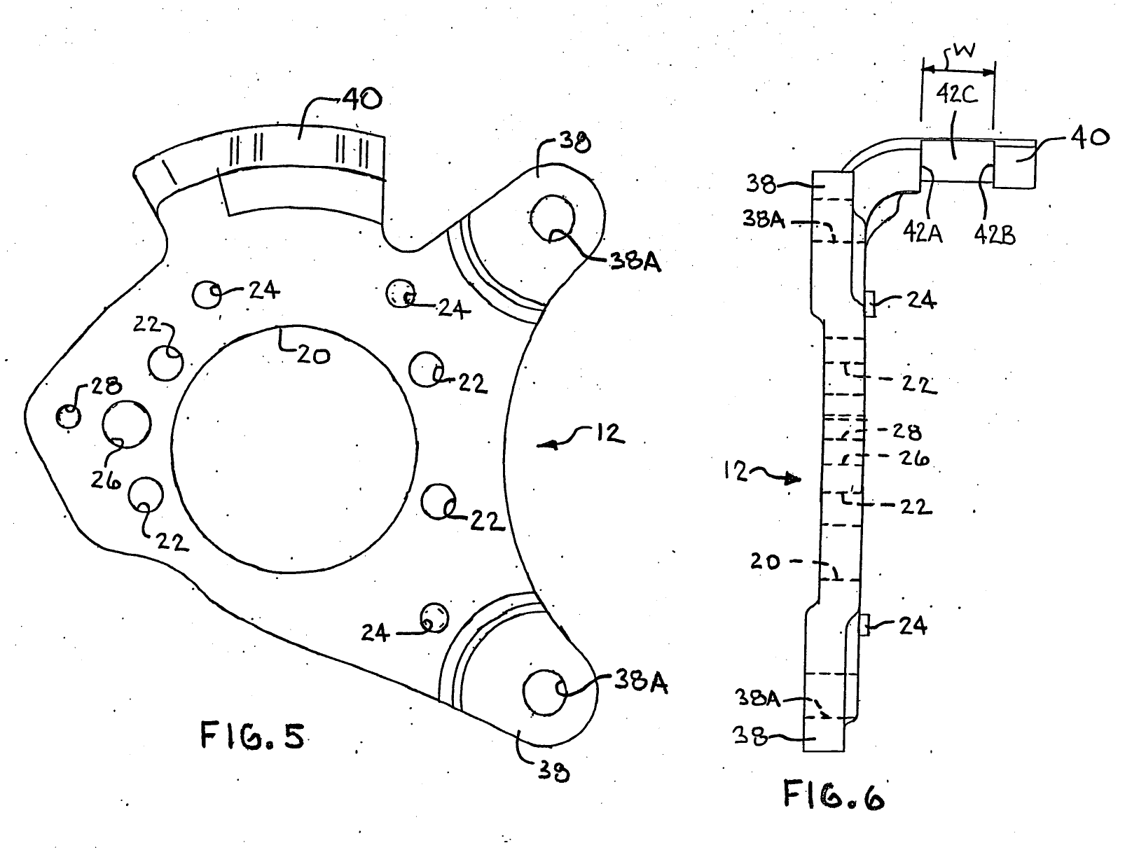

Preferably, the adapter 12 is adapted to be secured to a fixed, non-rotatable component of the vehicle, such as an axle flange (not shown) or a steering knuckle (not shown) for enclosing a rotatable axle (not shown). To accomplish this, the adapter 12 (best shown in FIGS. 4-6), includes a relatively large opening 20, and a plurality of holes 22 formed therein about the opening 20, the illustrated adapter having four of such holes 22. The opening 20 permits an outer end of an axle to extend therethrough to the vehicle wheel (not shown), and suitable fasteners (not shown) are disposed in the holes 22 to secure the adapter 12 to the associated vehicle component. Alternatively, as will be discussed below, since the adapter 12 is stamped of a sufficient thickness (i.e., a thickness of approximately 12.5 mm (about 0.5 inches), the adapter 12 could be directly connected to the axle (i.e., to the axle tube), thereby eliminating the need and use of the axle flange.

In the illustrated embodiment, the adapter 12 includes a plurality of raised “solid” projections 24, an opening 26 and a threaded or tapped opening 28 adjacent the opening 26. In this embodiment, the adapter 12 includes three raised projections 24 (only two of such projections 24 shown in FIG. 4), for a purpose to be discussed below. In this embodiment, the opening 26 is adapted to receive an anti-lock brake sensor (not shown) and the threaded opening 28 is adapted to receive a threaded fastener (not shown) for attaching the sensor to the drum-in-hat disc brake assembly 10.

The adapter 12 further includes a pair of outwardly extending ears or lugs 38 and an abutment 40. The ears 38 are provided with holes 38A formed therein. A pair of suitable fasteners (not shown) are disposed in the holes 38A of the ears 38 to attach a disc brake caliper assembly (not shown) to the adapter 12.

According to the present invention, the abutment 40 of the adapter 12 is integrally stamped formed during the fabrication of the drum-in-hat adapter 12. In the illustrated embodiment, the abutment 40 includes a pair of opposed slots or recesses 42 formed therein. Preferably, as shown in the illustrated embodiment, the slots 42 are identical to one another and are generally U-shaped. As best shown in FIG. 6, each slot includes a pair of opposed side surfaces 42A and 42B and an end or bottom surface 42C. The side surfaces 42A and 42B extend generally parallel to one another. The end surface 42C extends generally perpendicular to the side surfaces 42A and 42B. The side surfaces 42A and 42B define a slot width W. Alternatively, the specific structure of the abutment 40 of the adapter 12 can be other than illustrated and described if so desired. For example, depending upon the particular brake construction and in particular the construction of the associated brake shoes, the abutment 40 could not have the slots 40 as shown and described in connection with the preferred embodiment. Also, in a brake design having a sliding shoe type of drum-in-hat disc brake assembly, the abutment could have an appropriately shaped profile for receiving an associated end of a brake shoe. In some instances, the abutment 40 may require subsequent machining depending upon the particular brake design. Further, the construction of the adapter 12 can be other than illustrated and described in connection with the preferred embodiment, if so desired. For example, the size, number and/or the location of one or more of the openings 20, 22, 24, 26 and 28 can be other than illustrated and described if so desired.

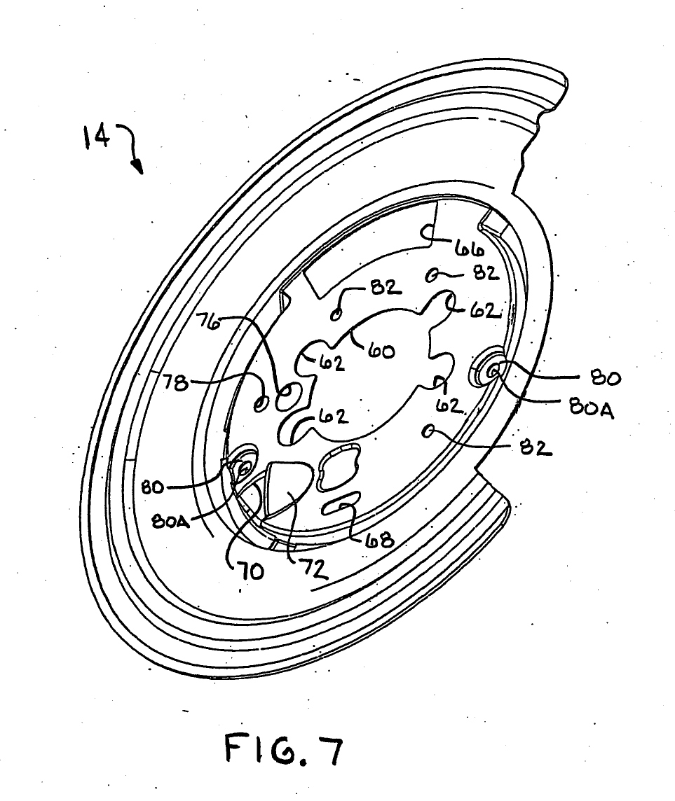

As best shown in FIG. 7, the illustrated backing plate 14 of the drum-in-hat disc brake assembly 10 is preferably a stamped metal backing plate and includes a relatively large central non-uniform opening 60 having a plurality of smaller openings or cut-outs 62 formed therein about the opening 20. In the illustrated embodiment, the backing plate 14 is provided with four of such openings 62. The central opening 20 permits an outer end of the rotatable axle (not shown) to extend therethrough to a wheel (not shown) of the vehicle. The openings 62 are adapted to allow suitable fasteners, such as threaded mounting studs (not shown), to be used to secure the adapter 12 to be secured to the associated vehicle component. The studs extend and pass freely through the openings 62 and the corresponding openings 22 formed in the drum-in-hat adapter 12 and nuts (not shown) are installed thereon to secure the backing plate 14 and the drum-in-hat adapter 12, and therefore the drum-in-hat disc brake assembly 10, to the associated vehicle component.

In the illustrated embodiment, the backing plate 14 also includes a generally elongated, slotted first opening 66, a generally elongated, slotted second opening 68, a slotted third opening 70, and a “frog-eye” bump 72. The slotted first opening 66 is adapted to allow the abutment member 40 of the drum-in-hat adapter 12 to extend therethrough. The slotted second opening 68 is adapted to allow a suitable tool (not shown) to extend therethrough to adjust a pad wear adjustment mechanism 100 of the brake assembly 10. The slotted third opening is adapted to allow a cable portion 102 of the parking and emergency brake actuation mechanism 16 to extend therethrough.

The backing plate 14 further includes an opening 76, an opening 78, a pair of raised shoe supports 80, and a plurality of raised or embossed “hollow” projections 82. The openings 76 and 78 are adapted to be aligned with the openings 26 and 28 of the adapter 12 for 26 for securing receiving and attaching the anti-lock brake sensor to the drum-in-hat disc brake assembly 10. The shoe supports 80 having an opening 80A formed therethrough and are adapted to receive pins 104 of conventional pivot pin and spring-clip assemblies, indicated generally at 106. The pins 104 are adapted to extend through the openings 80A of the backing plate 14 and through associated openings (not shown) provided in a pair of brake shoes 110. The pins 104 have outer ends which are adapted to be fastened or secured to clips 108 of the spring-clip assemblies 106 to secure the brake shoes 100 to the backing plate 14 in a conventional manner. The illustrated drum-in-hat brake assembly 10 also includes a pair of retraction springs 112 and 114.

In the illustrated embodiment, the backing plate 14 is preferably provided with three raised or embossed projections 82. The projections 82 are adapted to be aligned with and receive the raised projections 24 of the adapter 12 to secure the backing plate 14 and the adapter 12 together. To accomplish this, a suitable tool (not shown) is used to preferably peen over the material of the raised members 82 about the material of the raised projections 24 to thereby secure the backing plate 14 and the adapter 12 together. Alternatively, instead of or in addition to this method for securing the backing plate 14 and the adapter 12 together other methods can be used. For example, one or more threaded fasteners 90 (only one of such fasteners 90 being illustrated in FIG. 1), can extend through respective openings (one of such openings 92 being illustrated in FIG. 4), provided in the backing plate 14 and can be received in the adapter 12; and/or the threaded mounting studs (not shown) which extend through the openings 62 to secure the adapter 12 to the associated vehicle component can also engage that portion of the material of the backing plate 14 adjacent the openings 62.

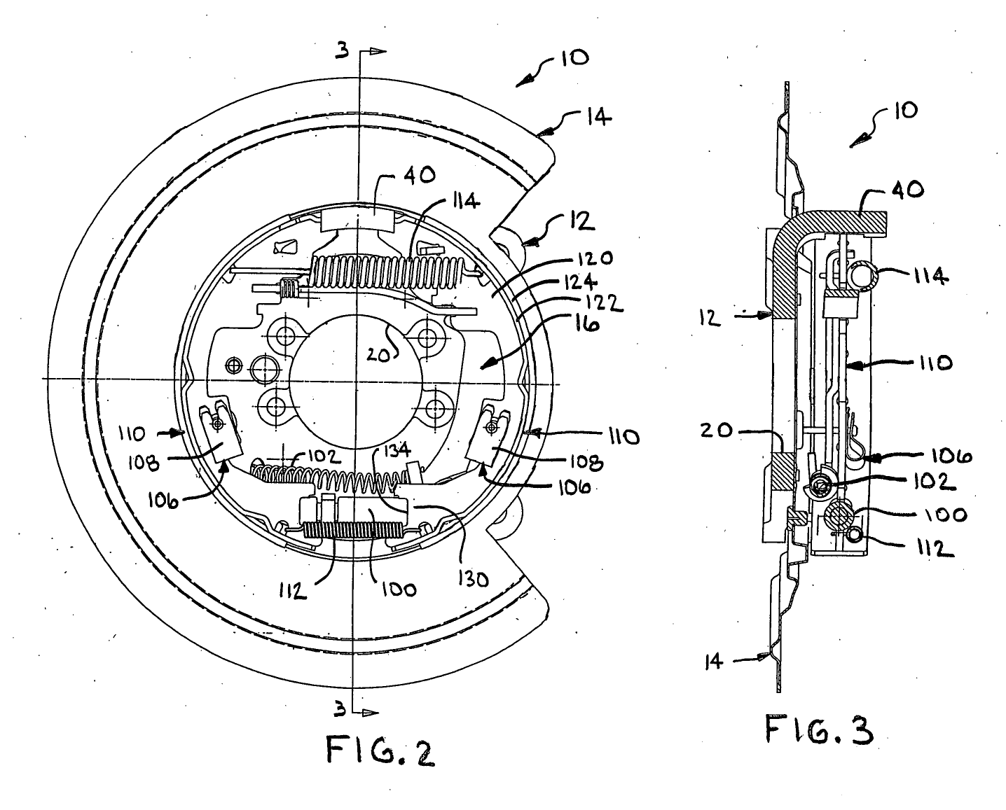

The drum-in-hat parking and emergency brake portion 16 of the brake assembly 10 includes the pair of brake shoes 110 supported on the backing plate 14 as described above. Structurally, the brake shoes 110 are essentially mirror images of one another. Each of the brake shoes 110 include a web portions 120 which is generally flat and crescent-shaped. A generally arcuate-shaped rim portion 122 is secured to the outer curved surface of the web portion 120, such as by welding. A friction pad 124 is secured to the outer arcuate surface of the rim portion 122 of the brake pad 100. In the illustrated embodiment, each of the brake shoe 110 is provided with two shoe slides or “gimps” 126 provided on each side of the rim portion 122 (only the two shoe slides 126 on an outwardly facing side of the rim portion 122 is illustrated in FIGS. 1 and 2).

In the illustrated embodiment, the brake shoe 110 includes a first end 130 and an opposite “necked down” or reduced width second end 132. The web portion 120 of the first end 130 of the brake shoe 110 includes a notch 134 formed therein. The notch 134 is adapted to receive an end portion of a part of the pad wear adjustment mechanism 100 in a conventional manner. In the illustrated embodiment, the second end 122 of the brake shoe 100 defines a generally T-shaped shoe abutment, indicated generally at 136. The T-shaped shoe abutment end 136 is adapted to be received in the recess 42 of the abutment 30. Alternatively, the structure of the brake shoes 110 can be other than illustrated if so desired. For example, if the abutment 40 does not include the slots 42, the structure 110 of the second end 132 of the brake shoe 110 can be other than illustrated (i.e., not be T-shaped but include a notch formed therein generally similar to the notch 134 shown with respect to the first end 130). Alternatively, the structure of the adapter 12, backing plate 14 and/or the other components of the drum-in-hat disc brake assembly 10 can be other than illustrated if so desired.

Turning now to FIG. 8 and using like reference numbers to indicate corresponding parts, there is illustrated a schematic diagram showing a portion of a vehicle 198, including the first embodiment of the vehicle drum-in-hat disc brake assembly 10, illustrated in FIGS. 1-3. As shown therein, the adapter 12 is connected to a secured to a fixed, non-rotatable component of the vehicle 202, such as an axle flange or a steering knuckle, which in turn is connected to an axle tube 200. The backing plate 14 is connected to the adapter 12, and the other associated components of the parking brake portion, indicated generally at 204, of the drum-in-hat disc brake assembly, are connected to the backing plate 14.

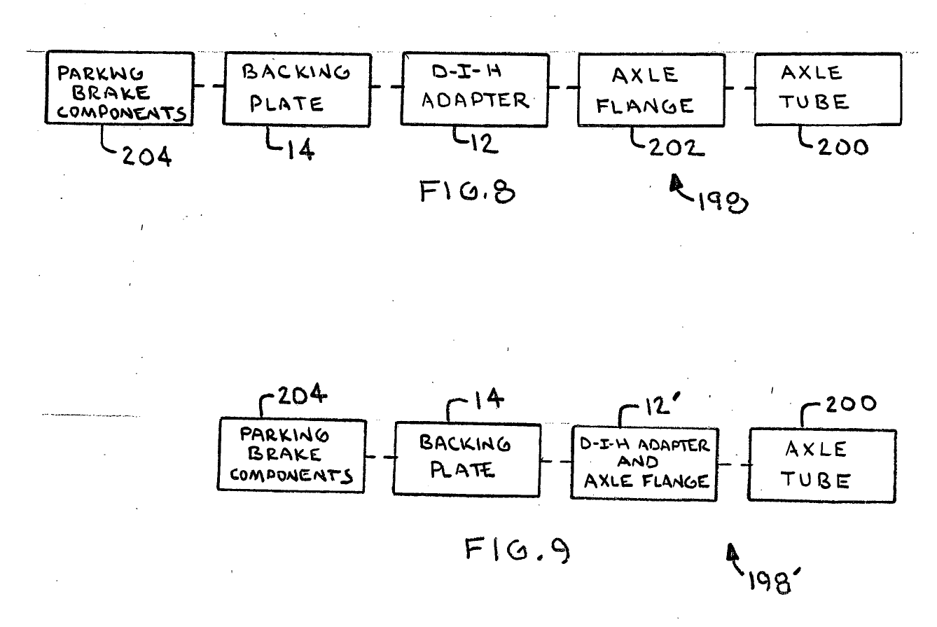

Turning now to FIG. 9 and using like reference numbers to indicate corresponding parts, there is illustrated a black box diagram showing a portion of a vehicle 198′, including a portion of a second embodiment of a vehicle drum-in-hat disc brake assembly 10′, constructed in accordance with this invention, attached to a portion of the vehicle. As shown in this embodiment, the vehicle drum-in-hat disc brake assembly includes a “combination” or integral adapter and axle flange 12′ which is connected to the axle tube 200. The backing plate 14 is connected to the adapter and axle flange 12, and the other associated components of the parking brake portion, indicated generally at 204, of the drum-in-hat disc brake assembly, are connected to the backing plate 14.

One advantage of the present invention is that the drum-in-hat disc brake assembly includes an adapter which is formed as a stamping and which includes an integral abutment member as part of the stamping. As a result, the conventional use of a separate abutment member, which requires associated attachment methods, such as bolting or riveting, is eliminated. Also, the integral stamped adapter of the present invention can be formed of a sufficient material thickness so as to have a sufficient strength, so that the integral stamped adapter can also function as the axle flange. As a result, the integral stamped adapter of the present invention can eliminate the need of a conventional separate axle flange.

In accordance with the provisions of the patent statutes, the principle and mode of operation of this invention have been described and illustrated in its preferred embodiments. However, it must be understood that the invention may be practiced otherwise than as specifically explained and illustrated without departing from the scope or spirit of the attached claims.

1. A vehicle brake assembly comprising:
a backing plate having a centrally located first aperture formed therein, said backing plate adapted to support a drum brake shoe assembly of a drum-in-hat parking and emergency brake; and
a drum-in-hat adapter having a centrally located second aperture and a plurality of smaller mounting apertures formed therein about said centrally located first aperture thereof, said adapter being formed as a one piece stamping and including an integral abutment member formed therewith during the stamping thereof.

2. The vehicle brake assembly according to claim 1 wherein said backing plate includes at least one raised hollow projection and said adapter includes at least one raised solid projection which is adapted to be received into said at least one raised hollow projection and subjected to a metal forming operation to secure said backing plate to said adapter.

3. The vehicle brake assembly according to claim 1 wherein said adapter functions as an axle flange and is adapted to be secured to a vehicle axle tube.

4. The vehicle brake assembly according to claim 1 and further including an axle flange, said axle flange adapted to be secured to an axle tube which in turn is adapted to extend through the centrally located first and second apertures of said backing plate and said adapter, respectively.

5. The vehicle brake assembly according to claim 1 wherein said adapter is stamp formed from carbon steel or a high strength low alloy material.

6. The vehicle brake assembly according to claim 1 wherein said adapter has a generally uniform thickness of approximately 12.5 mm (approximately 0.5 inches).

7. The vehicle brake assembly according to claim 1 wherein said adapter includes a pair of ears, each of said ears provided with a hole formed therein and adapted to receive a fastener for attaching a disc brake caliper assembly to said adapter.

8. A vehicle drum-in-hat disc brake assembly having a disc service brake and a drum-in-hat parking and emergency brake, the vehicle drum-in-hat disc brake assembly comprising:
a backing plate having a centrally located first aperture formed therein;
a drum brake shoe assembly of the drum-in-hat parking and emergency brake supported by said backing plate; and
a drum-in-hat adapter having a centrally located second aperture and a plurality of smaller mounting apertures formed therein about said centrally located first aperture thereof, said adapter being formed as a one piece stamping and including an integral abutment member formed therewith during the stamping thereof.

9. The vehicle drum-in-hat disc brake assembly according to claim 8 wherein said backing plate includes at least one raised hollow projection and said adapter includes at least one raised solid projection which is adapted to be received into said at least one raised hollow projection and subjected to a metal forming operation to secure said backing plate to said adapter.

10. The vehicle drum-in-hat disc brake assembly according to claim 8 wherein said adapter functions as an axle flange and is adapted to be secured to a vehicle axle tube.

11. The vehicle drum-in-hat disc brake assembly according to claim 8 and further including an axle flange, said axle flange adapted to be secured to an axle tube which in turn is adapted to extend through the centrally located first and second apertures of said backing plate and said adapter, respectively.

12. The vehicle drum-in-hat disc brake assembly according to claim 8 wherein said adapter is stamp formed from carbon steel or a high strength low alloy material.

13. The vehicle drum-in-hat disc brake assembly according to claim 8 wherein said adapter has a generally uniform thickness of approximately 12.5 mm (approximately 0.5 inches).

14. The vehicle drum-in-hat disc brake assembly according to claim 8 wherein said adapter includes a pair of ears, each of said ears provided with a hole formed therein and adapted to receive a fastener for attaching a disc brake caliper assembly to said adapter.

15. A drum-in-hat adapter adapted for use in a vehicle drum-in-hat disc brake assembly comprising:
a drum-in-hat adapter having a centrally located aperture and a plurality of smaller mounting apertures formed therein about said centrally located aperture thereof,
wherein said adapter is formed as a one piece stamping and including an integral abutment member formed therewith during the stamping thereof.

16. The drum-in-hat adapter according to claim 15 wherein said adapter includes at least one raised solid projection formed thereon.

17. The vehicle drum-in-hat disc brake assembly according to claim 15 wherein said adapter functions as an axle flange and is adapted to be secured to a vehicle axle tube.

18. The vehicle drum-in-hat disc brake assembly according to claim 15 wherein said adapter is stamp formed from carbon steel or a high strength low alloy material.

19. The vehicle drum-in-hat disc brake assembly according to claim 15 wherein said adapter has a generally uniform thickness of approximately 12.5 mm (approximately 0.5 inches).
